(19) United States
(12) Patent Application Publication
(10) Pub. No.: US 2018/0150501 A1
(43) Pub. Date: May 31, 2018

(54) DATABASE SYSTEM, SERVER DEVICE, COMPUTER PROGRAM PRODUCT, AND INFORMATION PROCESSING METHOD

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Masakazu Hattori, Inagi Tokyo (JP)

(21) Appl. No.: 15/880,616

(22) Filed: Jan. 26, 2018

Related U.S. Application Data
(63) Continuation of application No. PCT/JP2015/075507, filed on Sep. 8, 2015.

(51) Int. Cl. G06F 17/30

(52) U.S. Cl. CPC G06F 17/30368; G06F 17/30581

(57) ABSTRACT

According to an embodiment, a database system includes a client device and server devices including a master server and at least one slave server for backing up the master. Each server device includes an operation unit, a log processor, and a recovery unit. The operation unit causes the identifier memory unit to store the identifier when changing the database according to the operation information. The log processor causes the log storage to store a log including the identifier when the database is changed. The recovery unit, when the server restarts, restores the database based on the log and restores a list of the identifier based on the identifier included in the log. The operation unit does not change the database according to the operation information in a case where the identifier of the operation information received from the client device is stored in the identifier memory unit.

### CROSS-REFERENCE TO RELATED APPLICATIONS

This application is a continuation of PCT international application Ser. No. PCT/JP2015/075507 filed on Sep. 8, 2015, the entire contents of which are incorporated herein by reference.

### FIELD

Embodiments described herein relate generally to a database system, a server device, a computer program product, and an information processing method.

### BACKGROUND

In recent years, database systems that have been made highly available by multiplexing databases are used for services that cannot be stopped for operations such as 24 hours and 365 days. As a highly available database system, for example, a system in which each of a plurality of server devices has a separate database is known. In this system, one server device operates as a master and the other server device operates as a slave.

The master is a server device that accepts database update directly from a client device. A slave is a server device having a master copy database. When the master server device updates the database, the slave server device performs the same update processing as the master. As a result, in the database system, it is possible to synchronize the databases between the master and the slave and maintain the consistency of the data. The processing of synchronizing data between master and slave is called replication.

In addition, the slave functions as a backup of the master. When a failure occurs in the master server device, one of the slaves is changed to the master. As a result, the database system can continue the service without stopping the service even if some server devices fail. When the server of the master fails, the processing of changing the server device of the slave to the master is called failover.

In addition, when a failover occurs, an error occurs in the connection with the master server device, so that it is necessary for the client device to reconnect with the new master server device after completion of the failover. In this case, the client device executes a processing of hiding the connection error and minimizing interruption to the application of the upper layer. Thus, the client device does not have to make the application execute processing for reconnection, so that the development burden of the application can be reduced.

When failover occurs, the client device automatically reconnects to the new master server device. As a method of automatically reconnecting, there is known a method of adding an ID for each transaction and caching the ID of the transaction which has been executed by each of the master and the slave. In this method, when a transaction is interrupted by failover, after completion of the failover, the client device retransmits the execution request of the suspended transaction by adding the same ID to the new master server device. When the same ID is cached, the new master server device ignores the retransmitted request. When the same ID is not cached, the new master server device executes the transaction in response to the retransmitted request. As a result, in the database system, when failover occurs, it is possible to eliminate duplicate execution of the same transaction.

In such a database system, when the master server device is restarted due to, for example, a network error, the same server device may be selected again as a master after restarting. In this case, in the master server device, the cached ID is cleared. Therefore, in this case, when the same request is retransmitted from the client device, the master server device cannot ignore the request and duplicates the transaction.

Particularly, in recent years, technology of virtualization of server devices has advanced. A virtualized server device tends to be restarted due to an increase in the load of the physical server, maintenance, or the like. Therefore, when the virtualized server device is used as the server device of the database system, there is a high possibility that the operation information is duplicately executed.

### BRIEF DESCRIPTION OF THE DRAWINGS

FIG. 1 is a diagram illustrating a configuration of a database system according to an embodiment;

FIG. 2 is a diagram illustrating a flow of a processing of setting a master and a slave by an arbitration device;

FIG. 3 is a diagram illustrating a flow of an operation of a database and replication by a client device;

FIG. 4 is a diagram illustrating a state in which a master server device has failed;

FIG. 5 is a diagram illustrating a flow of processing after a master server device has failed;

FIG. 6 is a diagram illustrating a configuration of a client device;

FIG. 7 is a diagram illustrating a configuration of a server device;

FIG. 8 is a flowchart illustrating processing of a client device;

FIG. 9 is a flowchart illustrating processing of a master server device;

FIG. 10 is a flowchart illustrating processing of a slave server device;

FIG. 11 is a flowchart illustrating processing of a server device at the time of recovery;

FIG. 12 is a diagram illustrating a flow of processing at the time of database operation;

FIG. 13 is a diagram illustrating a flow of processing at the time of failure;

FIG. 14 is a diagram illustrating a flow of processing when unprocessed operation information is retransmitted to the server device changed from the slave to the master;

FIG. 15 is a diagram illustrating a flow of processing when processed operation information is retransmitted to the server device changed from the slave to the master;

FIG. 16 is a diagram illustrating a flow of processing in a case where the master server device is restarted and set as a master again;

FIG. 17 is a diagram illustrating a flow of processing when the processed operation information is retransmitted to the server device again set as a master after restarting; and

FIG. 18 is a diagram illustrating a hardware configuration of an information processing device.

### DETAILED DESCRIPTION

According to an embodiment, a database system includes a client device and a plurality of server devices in which one of the server devices operates as a master and at least one of the other server devices operates as a slave for backing up the master and. Each of the plurality of server devices stores a database. The client device is configured to transmit operation information indicating an instruction for operation of the database to the master server device, and add an identifier for identifying the operation information to the operation information. Each of the plurality of server devices includes a data storage, an identifier memory unit, a log storage, an operation unit, a log processor, and a recovery unit. The data storage is configured to store the database. The identifier memory unit is configured to store a list of the identifier. The log storage is configured to store a log of a change of the database. The operation unit is configured to cause the identifier memory unit to store the identifier of the operation information when the operation unit changes the database stored in the data storage according to the operation information received from the client device. The log processor is configured to cause the log storage to store a log including the identifier of the operation information when the operation unit changes the database according to the operation information. The recovery unit is configured to, when the each of the plurality of server devices restarts, restore the database stored in the data storage based on the log stored in the log storage and restore a list of the identifier stored in the identifier memory unit based on the identifier included in the log stored in the log storage. The operation unit does not change the database according to the received operation information in a case where the identifier of the operation information received from the client device is stored in the identifier memory unit.

Hereinafter, the database system according to the embodiment will be described in detail with reference to the drawings. The database system according to the present embodiment aims to eliminate redundant execution when the same operation information is retransmitted from the client device.

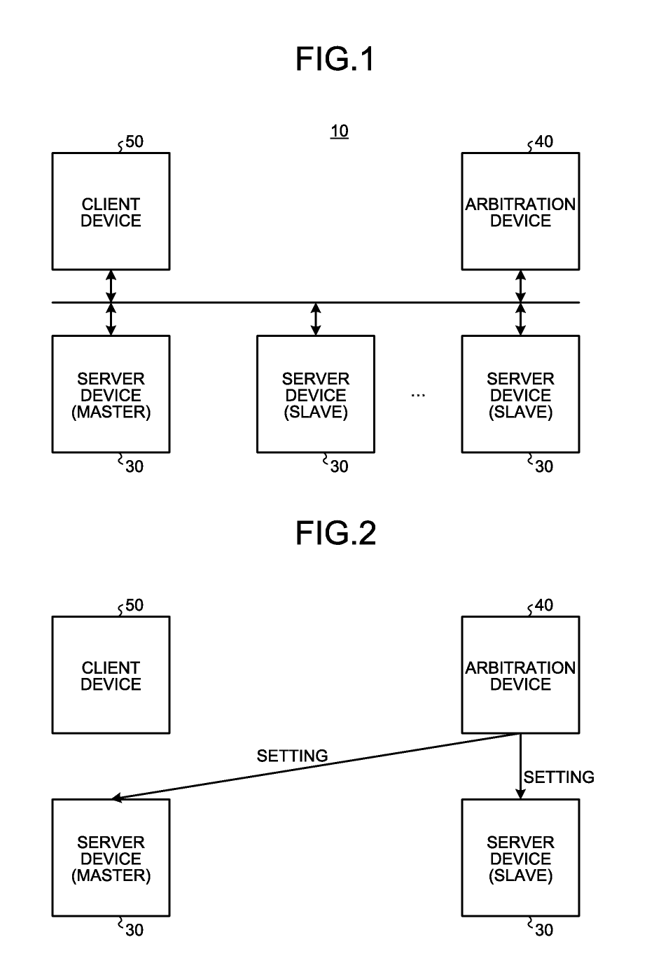

FIG. 1 is a diagram illustrating a configuration of the database system according to the embodiment. The database system 10 includes a plurality of server devices 30, an arbitration device 40, and a client device 50. Each of the plurality of server devices 30, the arbitration device 40, and the client device 50 is an information processing device and can be connected to each other via a network.

Each of the plurality of server devices 30 stores a database. One of the plurality of server devices 30 operates as a master and at least one other server device 30 operates as a slave to back up the master.

The master server device 30 receives operation information instructing the operation of the database from the client device 50. Operation of the database means, for example, reference, search, update, deletion, new registration, or the like of the record.

The slave server device 30 performs replication with the master server device 30 and executes the same change processing as the database of the master server device 30. More specifically, the master server device 30 transmits a log of the change of the database (update, deletion, new registration, or the like) to the slave server device 30. Upon receiving the log of the change of database, the slave server device 30 changes its own database according to the log. Thereby, each slave server device 30 can synchronize the database with the master server device 30. When a plurality of slave server devices 30 are set, the master server device 30 executes replication with each of the slave server devices 30.

The arbitration device 40 sets one of the plurality of server devices 30 in the master server device 30. Further, the arbitration device 40 sets at least one other than the master among the plurality of server devices 30 in the slave server device 30. Further, the arbitration device 40 monitors whether or not each server device 30 has failed. When the master server device 30 fails, the arbitration device 40 sets one of the slave server devices 30 in the master server device 30. In addition, when receiving an inquiry from the client device 50, the arbitration device 40 replies which one is the master server device 30.

The client device 50 transmits the operation information instructing the operation of the database to the master server device 30. Further, when the master server device 30 is unknown, the client device 50 inquires the arbitration device 40 and receives notification of the master server device 30. As a result, the client device 50 can transmit operation information to the master server device 30.

FIG. 2 is a diagram illustrating a flow of a processing of setting a master and a slave by the arbitration device 40. When starting a service, the arbitration device 40 sets the role of master or slave for each server device 30 when a failure occurs in any one of the server devices 30 or when a new server device 30 is added. In this case, the arbitration device 40 sets the roles so that the plurality of server devices 30 are not simultaneously set to the master.

Note that when any of the server devices 30 fails, or the like, the database system 10 may be configured not to include the arbitration device 40 if one of the plurality of server devices 30 that are not failing operates as a master and at least one of them operates as a slave. For example, at the timing of detecting a failure of the master or detecting addition of a new server device 30, each server device 30 acquires a specific disk lock. Each server device 30 operates as a master when the specific disk lock can be acquired, and operates as a slave when the specific disk lock cannot be acquired. Thereby, in the configuration without the arbitration device 40, the database system 10 can appropriately set roles in the respective server devices 30.

Further, for example, at the timing of detecting a failure of the master or detecting addition of a new server device 30, the plurality of server devices 30 mutually execute voting processing to vote for the server device 30 serving as the master. Then, the plurality of server devices 30 repeats the voting processing until the master is decided. Even in this case, the database system 10 can properly set roles in each server device 30 in the configuration without the arbitration device 40.

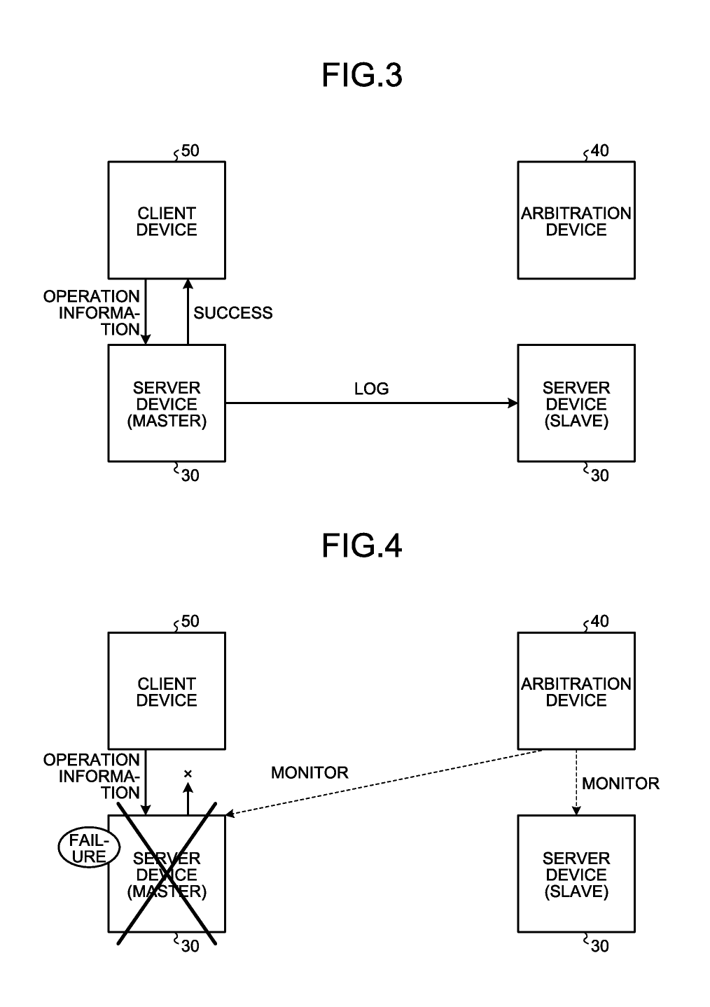

FIG. 3 is a diagram illustrating a flow of an operation of a database and replication by the client device 50.

When receiving an instruction to operate a database from an application of an upper layer, the client device 50 generates operation information and transmits the operation information to the master server device 30. The operation information may be, for example, a transaction execution request that summarizes a plurality of pieces of update processing and the like. Further, the operation information may be a database operation request by an SQL sentence. Further, the operation information may be a request to update, delete or newly register one record. Further, the operation information may be all information included in a session from execution of at least one transaction to termination of connection after the client device 50 connects to the master server device 30.

When receiving the operation information from the client device 50, the master server device 30 operates the database according to the operation information. When the operation of the database according to the operation information has succeeded, the master server device 30 returns information indicating that the client device 50 has succeeded. When the processing according to the operation information fails, the master server device 30 returns information indicating that the client device 50 has failed.

Further, when changing the database according to the operation information, the master server device 30 executes replication with the slave server device 30. Specifically, the master server device 30 transmits a log of the change of the database to the slave server device 30. The log of the change of the database may be any information as long as it is information in which history such as update, deletion or registration of the database can be conveyed. For example, the log of the change of the database may be an SQL statement representing the operation of the database or change data of the record level.

The slave server device 30 receives the log of the change of the database. Then, the slave server device 30 changes the database so as to make the same change as the received log. When there are a plurality of slave server devices 30, the master server device 30 executes replication with each of the slave server devices 30.

Further, replication can be divided into synchronous processing, asynchronous processing, or quasi-synchronous processing. In the synchronous processing, after the slave server device 30 changes the database, the database of the master server device 30 is changed. In the asynchronous processing, after the master server device 30 changes the database, the log is transmitted to the slave server device 30. In the quasi-synchronous processing, after confirming that the slave server device 30 has received the log, the master server device 30 changes the database.

In the present embodiment, the server device 30 executes replication by the synchronous processing. However, the server device 30 may execute replication by the asynchronous processing or quasi-synchronous processing.

FIG. 4 is a diagram illustrating a state in which the master server device 30 has failed. During operation of the service, the arbitration device 40 periodically receives a heartbeat (a packet indicating normal operation) from each server device 30 and monitors the operation of each server device 30. When the heartbeat cannot be received, the arbitration device 40 determines that the server device 30 has failed.

Furthermore, when the master server device 30 has failed, even if the client device 50 transmits the operation information, the client device 50 cannot receive the result. If the client device 50 cannot receive the result even if the predetermined time has elapsed since the operation information has been transmitted, the client device 50 determines that failover has occurred.

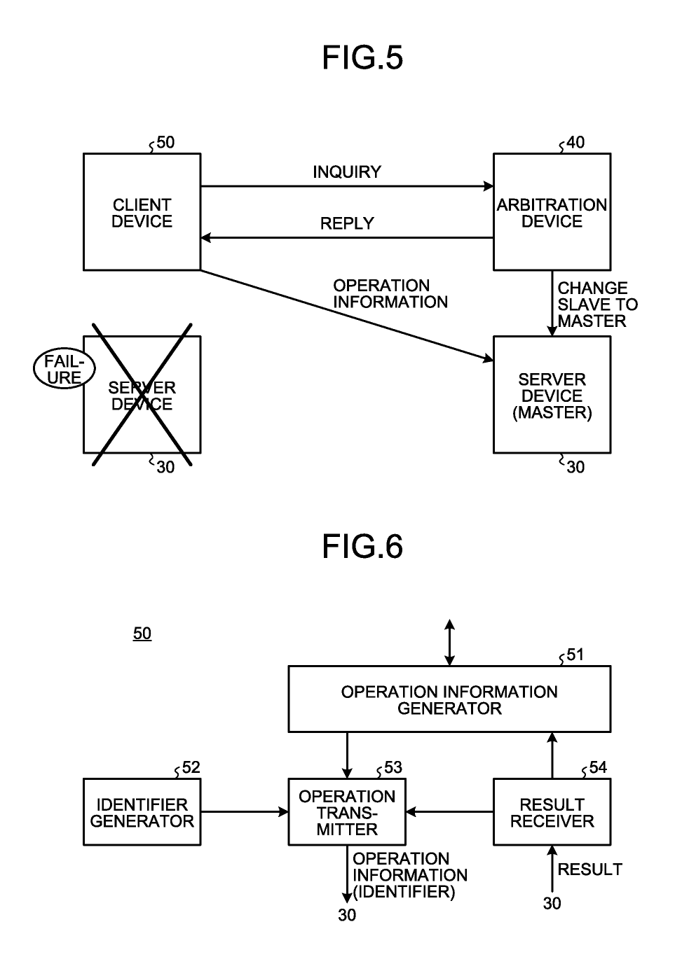

FIG. 5 is a diagram illustrating a flow of processing after the master server device 30 has failed. If it is determined that the master server device 30 has failed, the arbitration device 40 executes a failover to change one of the slave server devices 30 to the master server device 30.

In addition, since the client device 50 cannot receive the result even if the predetermined time elapses after transmitting the operation information, when determining that the failover has occurred, the client device 50 inquires the arbitration device 40 about the master server device 30. As an example, the client device 50 acquires the network address or the like of the master server device 30 as a reply. Then, the client device 50 retransmits the same operation information to the new master server device 30.

FIG. 6 is a diagram illustrating the configuration of the client device 50. The client device 50 includes an operation information generator 51, an identifier generator 52, an operation transmitter 53, and a result receiver 54.

The operation information generator 51 receives an operation instruction of the database from the application. Then, the operation information generator 51 generates operation information for causing the server device 30 to execute processing according to the operation instruction.

The identifier generator 52 generates a unique identifier for each operation information generated by the operation information generator 51. As an example, the identifier generator 52 generates an identifier based on a universally unique identifier (UUID) or the like. The identifier is transmitted to the server device 30 and held by the server device 30 for at least a certain period. The identifier may be unique within the range of the period held by the server device 30. Here, the certain period is a period from the failure of the master server device 30 to the start of operation of the new master server device 30, which is referred to as a failover time.

Further, the identifier generator 52 may generate an identifier based on information received from another device. For example, the identifier generator 52 may receive the identifier from the master server device 30 or another device and output the received identifier. Further, for example, the identifier generator 52 may receive information serving as an identifier from the master server device 30 or another device, and generate an identifier based on the received information.

The operation transmitter 53 adds the identifier generated by the identifier generator 52 to the operation information generated by the operation information generator 51. Then, the operation transmitter 53 transmits to the master server device 30 the operation information to which the identifier is added.

The result receiver 54 receives the result of the database operation according to the transmitted operation information from the master server device 30. When receiving the result indicating that the result has succeeded, the result receiver 54 returns the result to the operation information generator 51. When the result representing success is returned, the operation information generator 51 returns the result to the application.

In a case where the result receiver 54 has received a result representing failure or the result receiver 54 cannot receive the result even if a predetermined period has elapsed since the transmission of operation information (in the case of timeout), the result receiver 54 notifies the operation transmitter 53 of the reception failure and timeout. In this case, the operation transmitter 53 inquires the arbitration device 40 about the new master server device 30. Then, the operation transmitter 53 retransmits the same operation information to the new master server device 30 obtained by inquiry. In this case, the operation transmitter 53 adds the same identifier to the operation information.

It should be noted that even after the failover time has elapsed since the operation transmitter 53 has initially transmitted the operation information, when the result receiver 54 receives the result indicating that the failure has occurred or has timed out, the result receiver 54 does not cause the operation information generator 51 to retransmit the operation information but returns a result indicating that the operation has failed to the application.

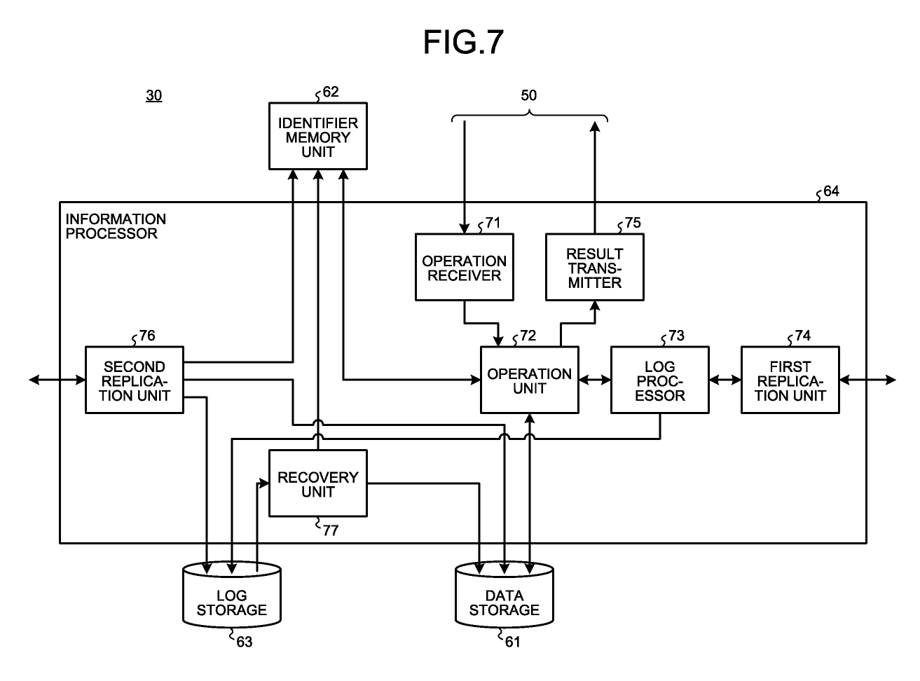

FIG. 7 is a diagram illustrating a configuration of the server device 30. The server device 30 includes a data storage 61, an identifier memory unit 62, a log storage 63, and an information processor 64.

The data storage 61 stores a database. The data storage 61 may be a nonvolatile storage device such as a hard disk or a volatile storage device such as a Random Access Memory (RAM).

The identifier memory unit 62 stores a list of identifiers. The identifier memory unit 62 is a volatile storage device such as a RAM. Accordingly, when the server device 30 is restarted, the identifier memory unit 62 clears the stored identifier list.

The log storage 63 stores a log of the change of the database. The log storage 63 is a nonvolatile storage device such as a hard disk. Therefore, even when the server device 30 is restarted, the log storage 63 keeps storing the stored log.

The information processor 64 is a functional block realized by a processor such as a CPU executing a program. A part of the functional configuration of the information processor 64 may be realized by hardware.

The information processor 64 includes an operation receiver 71, an operation unit 72, a log processor 73, a first replication unit 74, a result transmitter 75, a second replication unit 76, and a recovery unit 77. The operation receiver 71, the operation unit 72, the log processor 73, the first replication unit 74, and the result transmitter 75 are functional blocks for operating the server device 30 as a master. The second replication unit 76 is a functional block for operating the server device 30 as a slave.

The operation receiver 71 receives from the client device 50 the operation information to which the identifier is added. The operation unit 72 reads and manipulates the database from the data storage 61 according to the operation information received from the client device 50. For example, the operation unit 72 changes the database stored in the data storage 61 according to the operation information received from the client device 50.

Further, when changing the database according to the operation information received from the client device 50, the operation unit 72 causes the identifier memory unit 62 to store the identifier of the operation information. Further, when receiving the operation information from the client device 50, the operation unit 72 checks whether or not the identifier of the operation information received from the client device 50 is stored in the identifier memory unit 62. When the identifier of the operation information received from the client device 50 is stored in the identifier memory unit 62, the operation unit 72 does not change the database according to the received operation information. In addition, the operation unit 72 deletes from the identifier memory unit 62 the identifier of the operation information received before the time point a predetermined time before the present time. Here, the fixed time is the failover time.

The log processor 73 generates a log of the change of the database according to the operation information by the operation unit 72. Then, the log processor 73 adds the identifier of the operation information to the log of the change of the database according to the operation information. Further, the log processor 73 causes the log storage 63 to store the log to which the identifier is added.

The first replication unit 74 executes replication with the slave server device 30. Specifically, the first replication unit 74 transmits to the slave server device 30 the log to which the identifier is added.

The result transmitter 75 transmits the processing result corresponding to the operation information to the client device 50. For example, after the change of the database according to the replication and operation information is completed, the result transmitter 75 transmits to the client device 50 a result indicating that the processing corresponding to the received operation information has succeeded. Furthermore, for example, when the change of the database according to the replication or operation information fails, the result transmitter 75 transmits to the client device 50 a result indicating that the processing corresponding to the received operation information has failed.

When the identifier of the operation information received from the client device 50 is stored in the identifier memory unit 62, the result transmitter 75 transmits to the client device 50 a result indicating that the processing corresponding to the received operation information has succeeded.

The second replication unit 76 executes replication with the master server device 30. Specifically, the second replication unit 76 receives from the master server device 30 the log to which the identifier is added. Subsequently, the second replication unit 76 changes the database stored in the data storage 61 according to the log received from the master server device 30. In addition, the second replication unit 76 stores the log in the log storage 63. Further, the second replication unit 76 stores the identifier of the log in the identifier memory unit 62.

When the server device 30 is restarted, the recovery unit 77 restores the database stored in the data storage 61 based on the log stored in the log storage 63. For example, during normal operation, the recovery unit 77 periodically acquires an image of the database stored in the data storage 61 and stores the image in a nonvolatile storage device, for example. When restart is performed, the recovery unit 77 reads the image of the database at the time point closest to the failure occurrence point and stores the image in the data storage 61. Subsequently, the recovery unit 77 reads from the log storage 63 the log after the image is acquired, and restores the database to the point immediately before the failure occurrence based on the read log.

When the database is restored by the restart, the recovery unit 77 restores the list of identifiers stored in the identifier memory unit 62 based on the identifier of the log stored in the log storage 63.

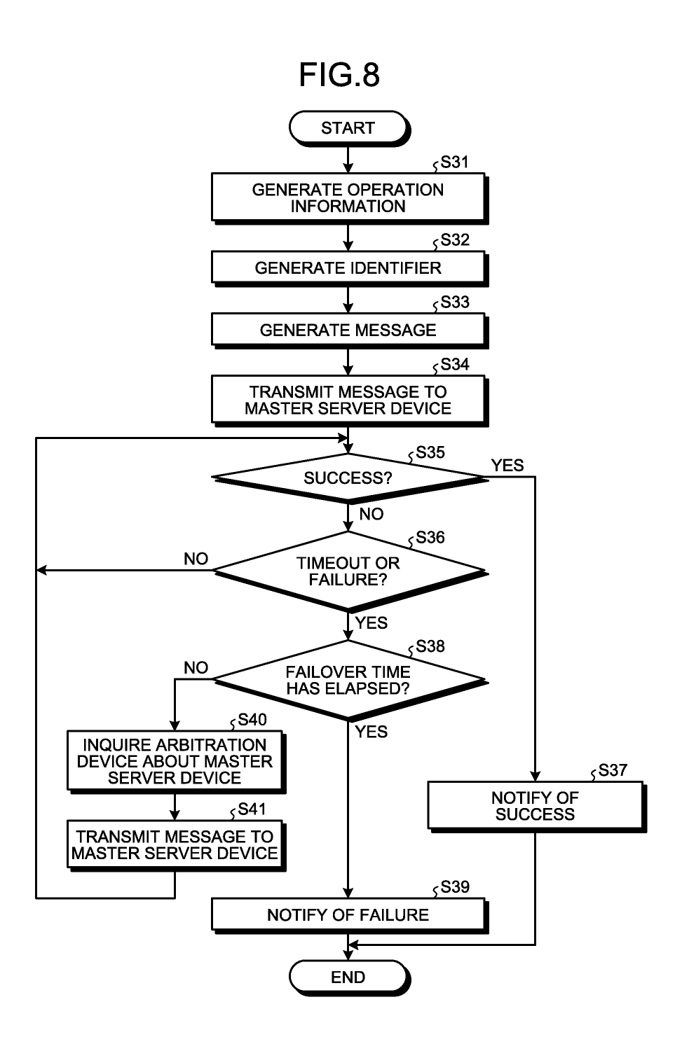

FIG. 8 is a flowchart illustrating processing of the client device 50. When receiving an instruction to operate the database from the application, the client device 50 executes the processing illustrated in FIG. 8.

First, the client device 50 generates operation information (step S31). Subsequently, the client device 50 generates an identifier (step S32). Subsequently, the client device 50 generates a message with an identifier added to the operation information (step S33). Subsequently, the client device 50 transmits a message to the master server device 30 (step S34).

Subsequently, the client device 50 determines whether or not a result indicating that the processing corresponding to the operation information has succeeded has been received from the master server device 30 (step S35). When the result indicating success has not been received (No in S35), the client device 50 determines whether the timeout has occurred after a predetermined time has elapsed since the transmission of the operation information or whether the result indicating that the processing corresponding to the operation information has failed has been received (step S36). If the client device 50 does not time out and also does not receive the result indicating that the failure has occurred (No in S36), the client device 50 returns the processing to step S35 and repeats the processing in steps S35 and S36.

If the result indicating success is received (Yes in S35), the client device 50 notifies the application that the operation of the database has succeeded (step S37), and ends this flow.

If a result indicating that the timeout or failure has been received (Yes in S36), the client device 50 determines whether or not the failover time has elapsed after first sending the operation information (step S38). When the failover time has elapsed (Yes in S38), the client device 50 notifies the application that the operation of the database has failed (step S39), and ends this flow.

When the failover time has not elapsed (No in S38), the client device 50 inquires the arbitration device 40 about the master server device 30 (step S40). Subsequently, the client device 50 transmits the same message, that is, the same operation information to which the same identifier is added, to the master server device 30 obtained by making an inquiry (step S41). Upon completion of step S41, the client device 50 returns the processing to step S35 and repeats the processing.

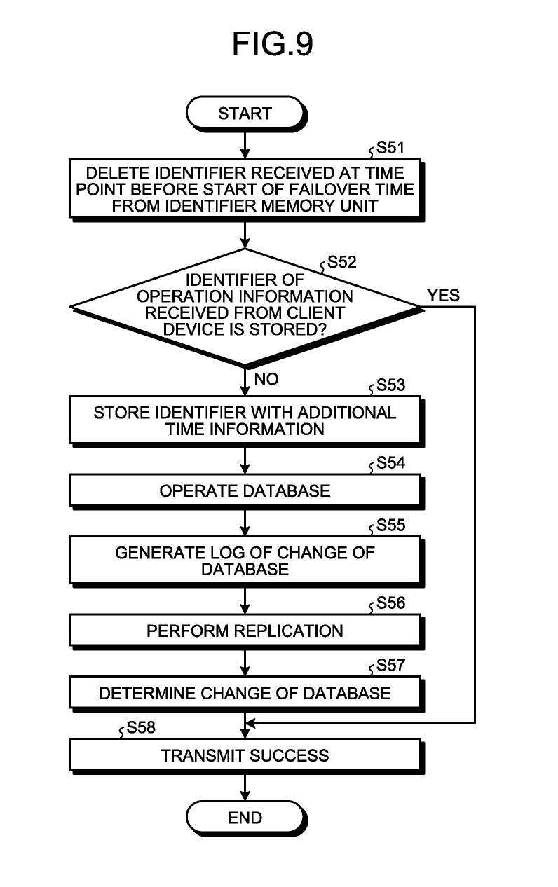

FIG. 9 is a flowchart illustrating processing of the master server device 30. When receiving a message (operation information to which an identifier is added) from the client device 50, the master server device 30 executes the processing illustrated in FIG. 9.

First, the operation unit 72 deletes from the list of identifiers stored in the identifier memory unit 62 the identifier received at a time point before the start of the failover time (step S51). As a result, the operation unit 72 can efficiently use the memory capacity by deleting unnecessary identifiers from the identifier memory unit 62.

Subsequently, the operation unit 72 checks whether or not the identifier of the operation information received from the client device 50 is stored in the identifier memory unit 62 (step S52). When the identifier of the operation information is stored in the identifier memory unit 62 (Yes in S52), the operation unit 72 does not execute any processing. Then, in this case (Yes in S52), the result transmitter 75 transmits to the client device 50 a result indicating that the processing corresponding to the received operation information has succeeded (step S58) and ends this flow.

If the identifier of the received operation information is not stored in the identifier memory unit 62 (No in S52), the operation unit 72 causes the identifier memory unit 62 to store the identifier of the received operation information (step S53). In this case, the operation unit 72 attaches the time information to the identifier. The time is, for example, the time when operation information is received. As a result, the operation unit 72 can delete from the identifier memory unit 62 the identifier received at the time point before the start of the failover time.

Subsequently, the operation unit 72 operates the database stored in the data storage 61 according to the received operation information (step S54).

Subsequently, the log processor 73 generates a log of the change of the database caused by the operation of the database (step S55). In this case, the log processor 73 adds the identifier of the operation information to the log of the change of the database. Then, the log processor 73 causes the log storage 63 to store the log to which the identifier is added.

Subsequently, the first replication unit 74 executes replication with the slave server device 30 (step S56). Specifically, the first replication unit 74 transmits to the slave server device 30 the log to which the identifier is added, and receives from the slave server device 30 the result indicating that the replication has succeeded.

Subsequently, the operation unit 72 rewrites the database stored in the data storage 61 to determine the change of the database caused by the operation of the database (step S57). Then, the result transmitter 75 transmits to the client device 50 a result indicating that the processing corresponding to the operation information has succeeded (step S58) and ends this flow.

If any of the processing from step S52 to step S58 has not succeeded, the result transmitter 75 transmits to the client device 50 a result indicating that the processing corresponding to the operation information has failed, and ends this flow. In this case, the operation unit 72 and the log processor 73 roll back the executed processing and return the data storage 61 and the log storage 63 to the state before receiving the operation information.

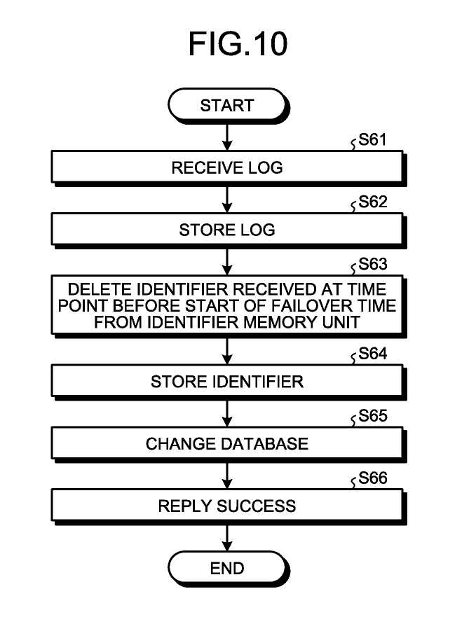

FIG. 10 is a flowchart illustrating processing of the slave server device 30. When receiving a replication execution request from the master server device 30, the slave server device 30 executes the processing illustrated in FIG. 10.

First, the second replication unit 76 receives a log attached with an identifier from the master server device 30 (step S61). Subsequently, the second replication unit 76 stores the log received from the master server device 30 in the log storage 63 with the identifier added (step S62). Subsequently, the second replication unit 76 deletes from the list of identifiers stored in the identifier memory unit 62 the identifier received at a time point before the start of the failover time (step S63).

Subsequently, the second replication unit 76 causes the identifier memory unit 62 to store the identifier added to the log received from the master server device 30 (step S64). In this case, the second replication unit 76 attaches the time information to the identifier. The time information is, for example, the reception time of the operation information to which the identifier is added. As a result, the second replication unit 76 can delete from the identifier memory unit 62 the identifier received at the time point before the start of the failover time.

Subsequently, the second replication unit 76 changes the database stored in the data storage 61 according to the log received from the master server device 30 (step S65). When the change of the database has succeeded, the second replication unit 76 returns a result indicating that the replication has succeeded to the master server device 30 (step S66) and ends this flow.

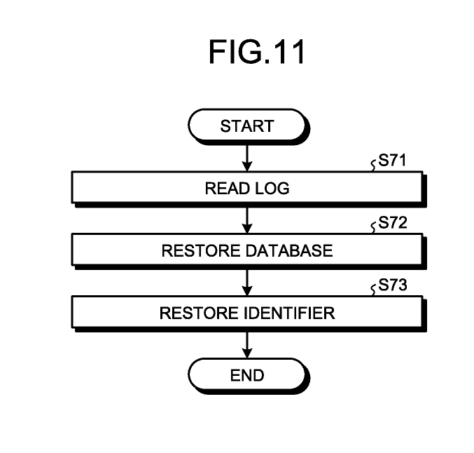

FIG. 11 is a flowchart illustrating processing of the server device 30 at the time of recovery. For example, when restarting due to an error in the network or the like, the server device 30 executes the recovery processing illustrated in FIG. 11.

First, the recovery unit 77 reads the log of the change of the database from the log storage 63 (step S71). When the image of the database stored in the data storage 61 is periodically acquired and stored in, for example, a nonvolatile storage device, the recovery unit 77 also reads the image of the latest database. In this case, the recovery unit 77 only needs to read the later log from the time of capturing the latest database image.

Subsequently, based on the read log, the recovery unit 77 restores the database stored in the data storage 61 to the state at the time of failure occurrence (step S72). As one example, the recovery unit 77 sequentially updates the image of the latest database based on the log, thereby restoring the database to the state when the failure has occurred.

Subsequently, the recovery unit 77 restores the list of identifiers stored in the identifier memory unit 62 based on the identifier of the log stored in the log storage 63 (step S73). Then, when the processing of step S73 is completed, the recovery unit 77 ends this flow.

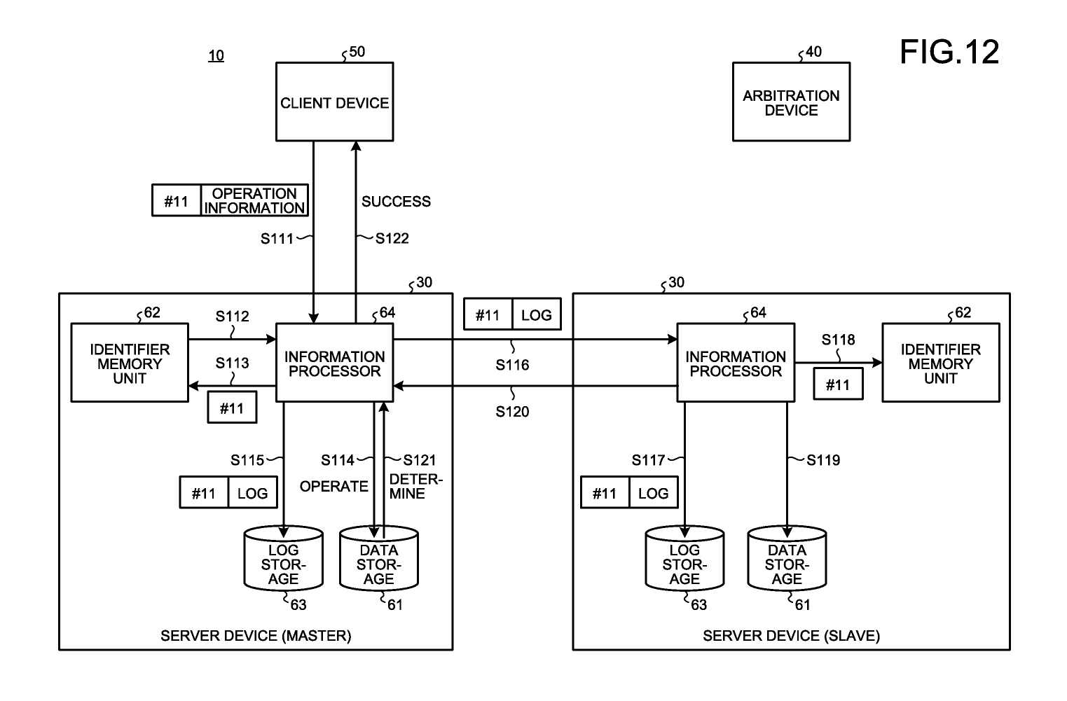

FIG. 12 is a diagram illustrating a flow of processing at the time of database operation. When manipulating the database, the database system 10 proceeds with the flow illustrated in FIG. 12.

First, the client device 50 transmits to the master server device 30 the operation information to which the identifier (for example, #11) is added (step S111). Subsequently, the information processor 64 of the master server device 30 checks whether or not the identifier of the received operation information is stored in the identifier memory unit 62 (step S112). When the identifier of the operation information is not stored in the identifier memory unit 62, the information processor 64 causes the identifier memory unit 62 to store the received identifier of the operation information (step S113).

Subsequently, the information processor 64 of the master server device 30 operates the database stored in the data storage 61 according to the operation information (step S114). Subsequently, the information processor 64 of the master server device 30 generates a log of the change of the database and stores the log in the log storage 63 (step S115). In this case, the information processor 64 adds the identifier of the operation information to the log.

Subsequently, the information processor 64 of the master server device 30 transmits to the information processor 64 of the slave server device 30 the log to which the identifier is added (step S116). Subsequently, the information processor 64 of the slave server device 30 stores the received log in the log storage 63 with the identifier added (step S117). Subsequently, the information processor 64 of the slave server device 30 causes the identifier memory unit 62 to store the identifier added to the received log (step S118). Subsequently, the information processor 64 of the slave server device 30 changes the database stored in the data storage 61 according to the received log (step S119). Then, the information processor 64 of the slave server device 30 transmits to the master server device 30 the processing result indicating that the replication has succeeded (step S120).

Subsequently, the information processor 64 of the master server device 30 determines the change of the database caused by the operation of the database by writing the change contents in the database in the data storage 61 (step S121). Then, the information processor 64 of the master server device 30 transmits to the client device 50 a result indicating that the processing corresponding to the operation information has succeeded (step S122).

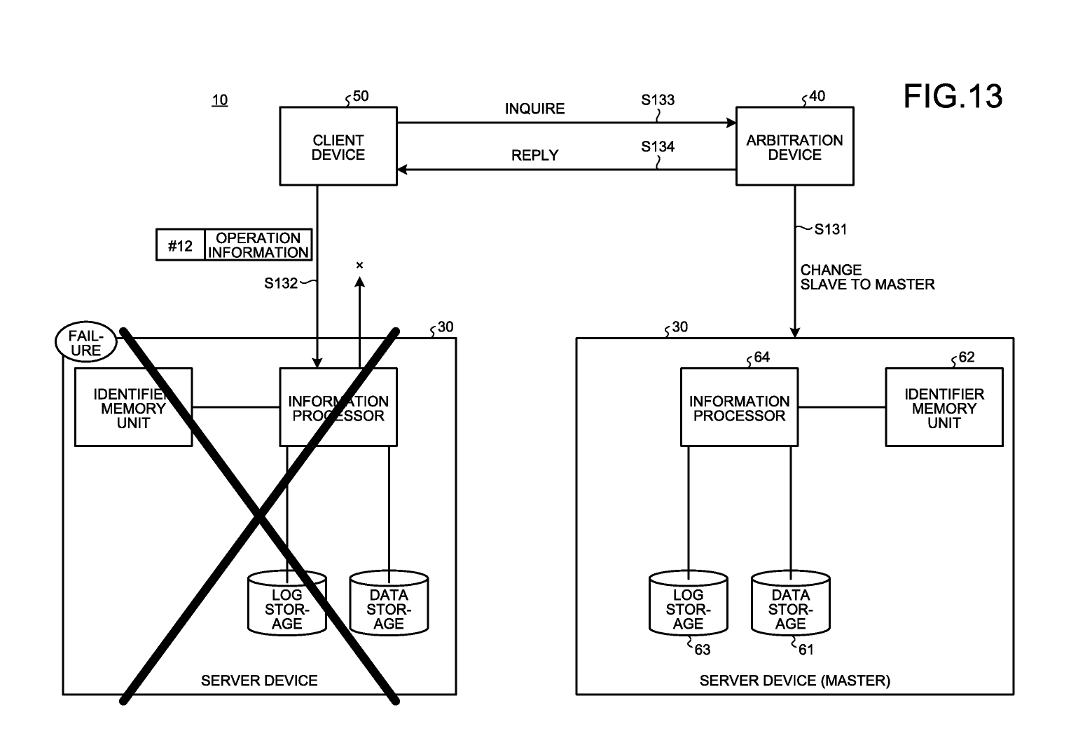

FIG. 13 is a diagram illustrating a flow of processing at the time of failure. In the database system 10, when the master server device 30 fails, the processing proceeds with the flow illustrated in FIG. 13.

When the master server device 30 fails, the arbitration device 40 changes one of the slave server devices 30 to a master (step S131). Subsequently, the client device 50 transmits to the original master server device 30 the operation information to which the identifier (for example, #12) is added (step S132). However, since the original master server device 30 has failed, the original master server device 30 cannot reply the processing result.

When the client device 50 times out due to elapse of a predetermined time since sending the operation information, the client device 50 inquires the arbitration device 40 about the master server device 30 (step S133). The arbitration device 40 replies the new master server device 30 to the client device 50 (step S134).

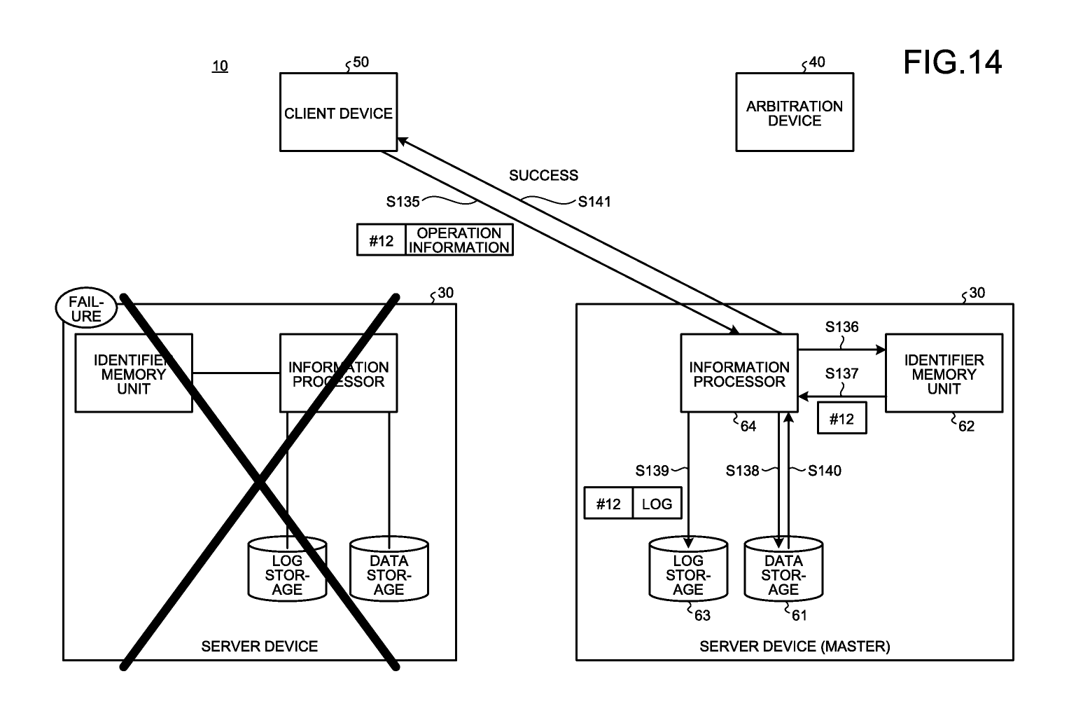

FIG. 14 is a diagram illustrating a flow of processing when unprocessed operation information is retransmitted to the server device 30 changed from the slave to the master. When the client device 50 retransmits the unprocessed operation information from the slave to the master server device 30, the database system 10 proceeds with the flow illustrated in FIG. 14 following the processing in FIG. 13.

First, the client device 50 retransmits to the new master server device 30 the operation information to which the identifier (for example, #12) is added (step S135). In this case, the client device 50 retransmits the same operation information and identifier as the operation information and the identifier transmitted to the original master server device 30.

Subsequently, the information processor 64 of the new master server device 30 checks whether or not the identifier of the received operation information is stored in the identifier memory unit 62 (step S136). In this example, since the server device 30 is unprocessed, the identifier memory unit 62 does not store the identifier (#12) of the operation information.

Subsequently, the information processor 64 of the new master server device 30 causes the identifier memory unit 62 to store the identifier of the received operation information (step S137). Subsequently, the information processor 64 of the new master server device 30 operates the database stored in the data storage 61 according to the operation information (step S138). Subsequently, the information processor 64 of the new master server device 30 generates a log of the change of the database and stores the log in the log storage 63 (step S139).

Subsequently, the information processor 64 of the new master server device 30 determines the change of the database caused by the operation of the database (step S140). Then, the information processor 64 of the master server device 30 transmits to the client device 50 a result indicating that the processing corresponding to the operation information has succeeded (step S141). When the slave server device 30 is set, the master server device 30 and the slave server device 30 execute replication.

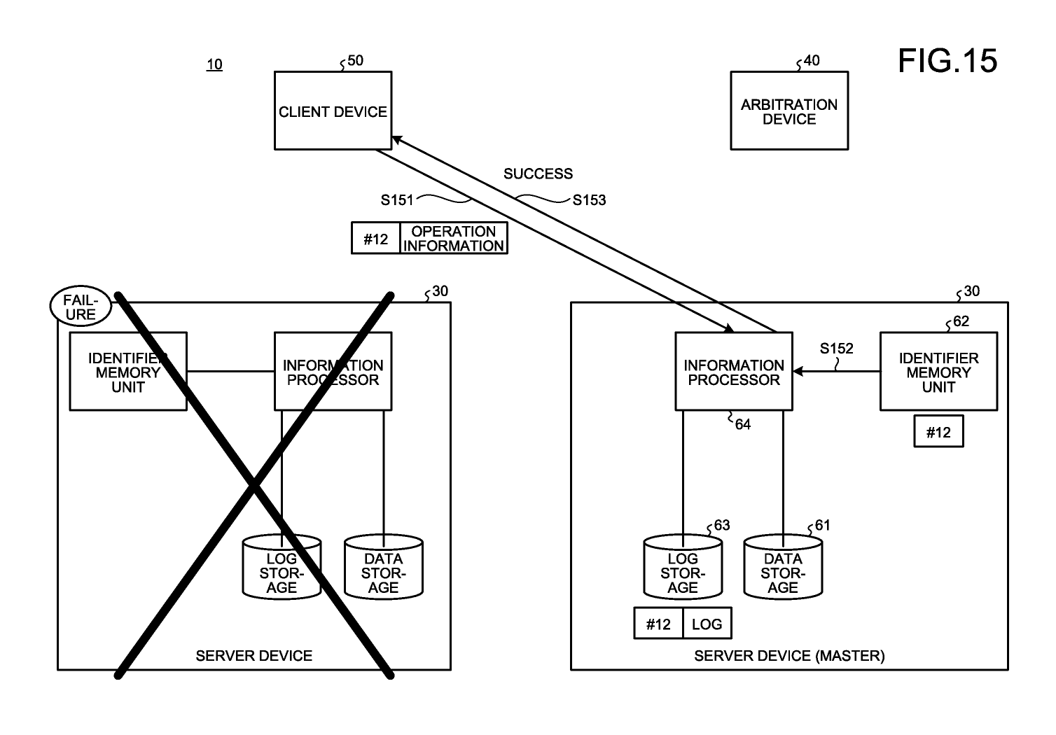

FIG. 15 is a diagram illustrating the flow of processing when the processed operation information is retransmitted to the server device 30 changed from the slave to the master.

When the replication is completed, the data storage 61 of the slave server device 30 stores the database after the change according to the operation information is completed. In the identifier memory unit 62 of the slave server device 30, an identifier (for example, #12) of operation information transmitted from the client device 50 is stored.

However, after completion of replication, it is assumed that the master server device 30 has failed before returning success to the client device 50. In this case, the client device 50 retransmits the same operation information added with the same identifier (for example, #12) to the new master server device 30 (step S151).

In this case, the identifier (#12) of the operation information has already been stored in the identifier memory unit 62 of the new master server device 30 which has been originally a slave (step S152). Therefore, the information processor 64 does not execute any processing on the database stored in the data storage 61. Then, the information processor 64 of the new master server device 30 transmits to the client device 50 a result indicating that the processing corresponding to the received operation information has succeeded (step S153).

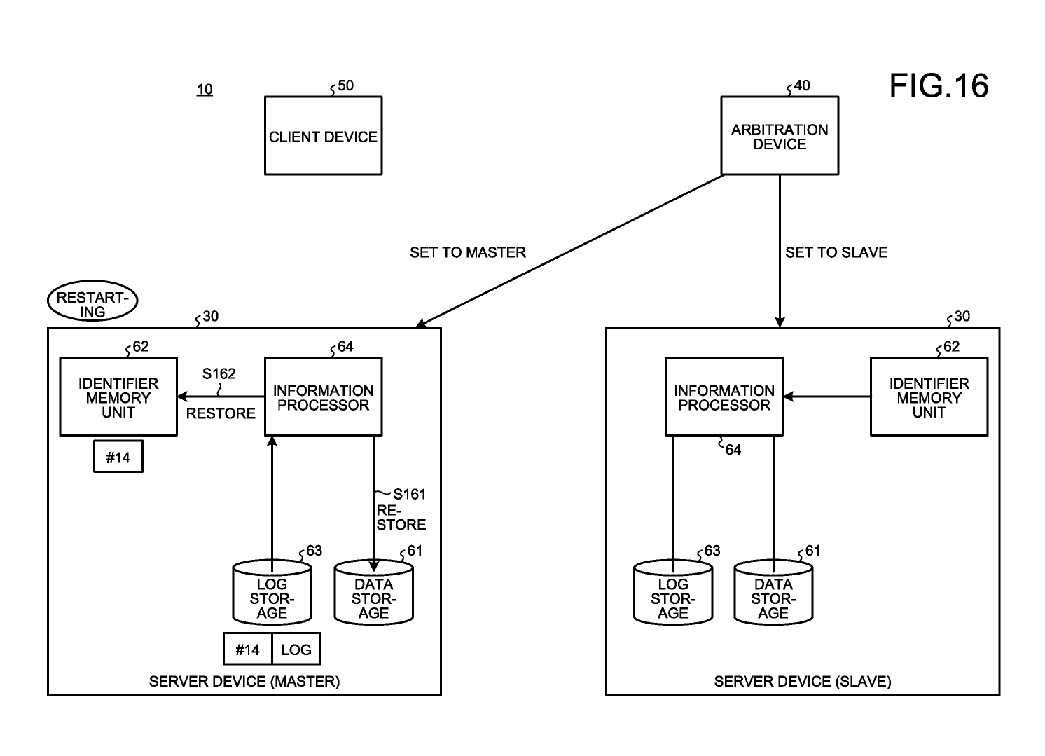

FIG. 16 is a diagram illustrating a flow of processing in a case where the master server device 30 is restarted and set as a master again.

When the generation and storage of the logs are completed, the log storage 63 of the master server device 30 stores the log of the change of the database according to the operation information. However, it is assumed that the network of the master server device 30 is temporarily disconnected, for example, after the storage of the log is completed, before sending the result indicating success to the client device 50. In this case, the master server device 30 restarts after shutting down.

When restarting, the information processor 64 of the server device 30 reads the log stored in the log storage 63, and restores the database stored in the data storage 61 to a state immediately before restarting (step S161). Further, when restarting, the information processor 64 of the server device 30 reads the identifier added to the log stored in the log storage 63, and restores the list of identifiers stored in the identifier memory unit 62 to the state immediately before restarting (step S162).

Furthermore, when the master server device 30 is restarted, the arbitration device 40 again sets the master and the slave. In this case, the arbitration device 40 may set the same server device 30 as a master.

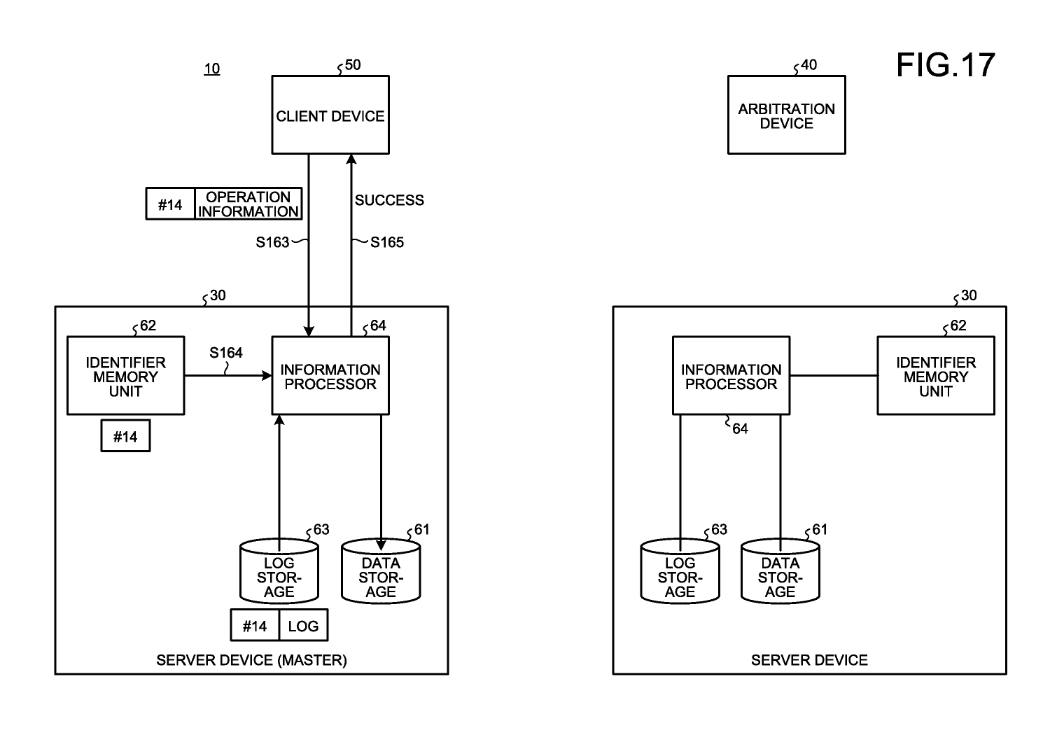

FIG. 17 is a diagram illustrating a flow of processing when the processed operation information is retransmitted to the server device 30 again set as a master after restarting.

For example, when the generation and storage of the log of the change of the database according to the operation information of an identifier (#14) is completed, the log storage 63 of the master server device 30 stores the log. In the identifier memory unit 62 of the master server device 30, an identifier (for example, #14) of the operation information transmitted by the client device 50 is stored.

However, it is assumed that after the storage of the log is completed, before transmitting the result indicating success, the master server device 30 shuts down, then restarts, and is set as the master again. In this case, the client device 50 retransmits the same operation information added with the same identifier (for example, #14) to the master server device 30 (step S163).

In this case, the identifier (#14) of the operation information is stored by restoration in the identifier memory unit 62 of the master server device 30 (step S164). Therefore, the information processor 64 does not execute any processing on the database stored in the data storage 61. Then, the information processor 64 of the master server device 30 transmits to the client device 50 a result indicating that the processing corresponding to the received operation information has succeeded (step S165).

As described above, according to the database system 10 of the present embodiment, since the identifier added to the operation information is added to the log of the change of database and stored, it is possible to eliminate redundant execution when the same operation information is retransmitted from the client device 50. For example, according to the database system 10, when the server device 30 is changed from the slave to the master, or even if the master server device 30 is set again as a master after restarting, the identifier added to the operation information can be restored from the log. Therefore, it is possible to eliminate redundant execution when the same operation information is retransmitted from the client device 50.

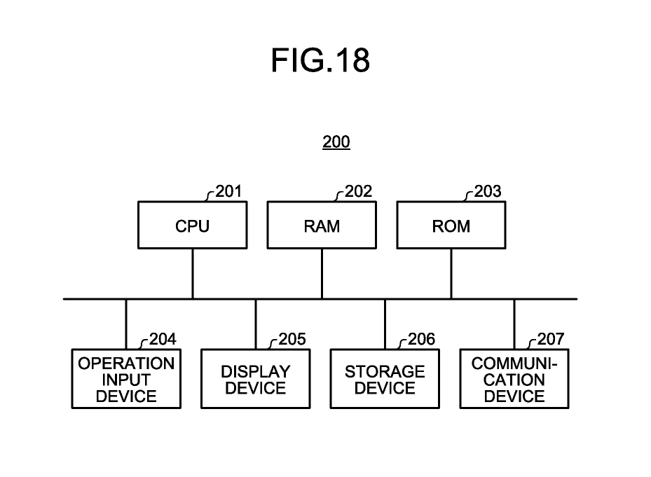

FIG. 18 is a diagram illustrating a hardware configuration of the information processing device 200 according to the embodiment. The server device 30, the arbitration device 40, and the client device 50 are realized by the information processing device 200 having a hardware configuration as illustrated in FIG. 18, for example.

The information processing device 200 includes a central processing unit (CPU) 201, a random access memory (RAM) 202, a read only memory (ROM) 203, an operation input device 204, a display device 205, a storage device 206, and a communication device 207. These components are connected by a bus.

The CPU 201 is a processor that executes arithmetic processing, control processing, and the like in accordance with a program. The CPU 201 executes various processing in cooperation with a program stored in the ROM 203, the storage device 206, and the like with a predetermined area of the RAM 202 as a work area.

The RAM 202 is a memory such as a synchronous dynamic random access memory (SDRAM). The RAM 202 functions as a work area of the CPU 201. The ROM 203 is a memory that stores programs and various information in a non-rewritable manner.

The operation input device 204 is an input device such as a mouse and a keyboard. The operation input device 204 accepts information input by a user as an instruction signal, and outputs an instruction signal to the CPU 201.

The display device 205 is a display device such as a liquid crystal display (LCD). The display device 205 displays various information based on a display signal from the CPU 201.

The storage device 206 is a device that writes and reads data to and from a semiconductor storage medium such as a flash memory or a magnetically or optically recordable storage medium or the like. In accordance with the control from the CPU 201, the storage device 206 writes and reads data to and from the storage medium. The communication device 207 communicates with an external device via a network under the control of the CPU 201.

The program executed by the server device 30 has a module configuration including an operation reception module, an operation module, a log processing module, a first replication module, a result transmission module, a second replication module, and a recovery module. This program is developed and executed on the RAM 202 by the CPU 201 (processor), thereby causing the information processing device 200 to function as the operation receiver 71, the operation unit 72, the log processor 73, the first replication unit 74, the result transmitter 75, the second replication unit 76, and the recovery unit 77. Note that the server device 30 is not limited to such a configuration, and may be a configuration in which at least a part of the operation receiver 71, the operation unit 72, the log processor 73, the first replication unit 74, the result transmitter 75, the second replication unit 76, and the recovery unit 77 is implemented by a hardware circuit (for example, a semiconductor integrated circuit).

The program executed by the client device 50 has a module configuration including an operation information generation module, an identifier generation module, an operation transmission module, and a result reception module. This program is developed and executed on the RAM 202 by the CPU 201 (processor), thereby causing the information processing device 200 to function as the operation information generator 51, the identifier generator 52, the operation transmitter 53, and the result receiver 54. The client device 50 is not limited to such a configuration, and may be a configuration in which at least a part of the operation information generator 51, the identifier generator 52, the operation transmitter 53, and the result receiver 54 is realized by a hardware circuit (for example, a semiconductor integrated circuit).

The program executed by the server device 30 or the client device 50 is a file that can be installed in a computer or in an executable format and is stored in a computer-readable recording medium such as a CD-ROM, a flexible disk, a CD-R, and a digital versatile disk (DVD), which may be provided as a computer program product.

In addition, the program executed by the server device 30 or the client device 50 may be stored on a computer connected to a network such as the Internet and provided by being downloaded via the network. Further, a program executed by the server device 30 or the client device 50 may be provided or distributed via a network such as the Internet. In addition, a program executed by the server device 30 or the client device 50 may be incorporated in advance in ROM or the like and provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A database system comprising:
a plurality of server devices each of which stores a database, one of the server devices operating as a master, at least one of the other server devices operating as a slave for backing up the master; and
a client device configured to transmit operation information indicating an instruction for operation of the database to the master server device, and add an identifier for identifying the operation information to the operation information,
each of the plurality of server devices including
a data storage configured to store the database;
an identifier memory unit configured to store a list of the identifier;
a log storage configured to store a log of a change of the database;
an operation unit configured to cause the identifier memory unit to store the identifier of the operation information when the operation unit changes the database stored in the data storage according to the operation information received from the client device;
a log processor configured to cause the log storage to store a log including the identifier of the operation information when the operation unit changes the database according to the operation information; and
a recovery unit configured to, when the each of the plurality of server devices restarts, restore the database stored in the data storage based on the log stored in the log storage and restore a list of the identifier stored in the identifier memory unit based on the identifier included in the log stored in the log storage,
the operation unit not changing the database according to the received operation information in a case where the identifier of the operation information received from the client device is stored in the identifier memory unit.

2. The system according to claim 1, wherein each of the plurality of server devices further includes
a first replication unit configured to transmit to the slave server device the log including the identifier; and
a second replication unit configured to receive the log including the identifier from the master server device and change the database stored in the data storage according to the log received from the master server device, and
when changing the database according to the log, the second replication unit causes the identifier memory unit to store the identifier of the log.

3. The system according to claim 1, wherein,
when retransmitting the same operation information to the master server device, the client device adds the same identifier to the operation information.

4. The system according to claim 3, wherein
the operation unit deletes from the identifier memory unit the identifier of the operation information received at a time point before a period of predetermined time before the present time.

5. The system according to claim 4, wherein when the change of the database according to the transmitted operation information is not successful and the period of predetermined time has not elapsed since the operation information is transmitted, the client device retransmits the same operation information to the master server device.

6. The system according to claim 5, further comprising an arbitration device configured to set one of the plurality of server devices to the master server device, wherein
the client device retransmits the same operation information to the master server device notified from the arbitration device when the change of the database according to the transmitted operation information is not successful.

7. The system according to claim 2, wherein the log storage stores the log received from the master server device.

8. The system according to claim 2, wherein each of the plurality of server devices further includes a result transmitter configured to transmit to the client device a result indicating that processing corresponding to the received operation information is successful, when the identifier of the operation information received from the client device is stored in the identifier memory unit.

9. The system according to claim 1, wherein the client device generates the unique identifier each time the operation information is generated.

10. The system according to claim 1, wherein the client device adds the identifier based on information received from another device to the operation information.

11. A sever device used in a database system that includes a plurality of server devices including the server device in which one of the server devices operating as a master and at least one of the other server devices operating as a slave for backing up the master and a client device, each of the plurality of server devices being configured to store a database, the client device being configured to transmit operation information indicating an instruction for operation of the database to the master server device, and add an identifier for identifying the operation information to the operation information, the server device including
a data storage configured to store the database;
an identifier memory unit configured to store a list of the identifier;
a log storage configured to store a log of a change of the database;
an operation unit configured to cause the identifier memory unit to store the identifier of the operation information when the operation unit changes the database stored in the data storage according to the operation information received from the client device;
a log processor configured to cause the log storage to store a log including the identifier of the operation information when the operation unit changes the database according to the operation information; and
a recovery unit configured to, when the each of the plurality of server devices restarts, restore the database stored in the data storage based on the log stored in the log storage and restore a list of the identifier stored in the identifier memory unit based on the identifier included in the log stored in the log storage,
the operation unit not changing the database according to the received operation information in a case where the identifier of the operation information received from the client device is stored in the identifier memory unit.

12. A computer program product comprising a computer-readable medium containing a program, wherein the program, when executed by a computer of an information processing device, causes the computer to function as the server device according to claim 11.

13. An information processing method executed in a database system that includes a plurality of server devices including the server device in which one of the server devices operating as a master and at least one of the other server devices operating as a slave for backing up the master and a client device, each of the plurality of server devices being configured to store a database, the client device being configured to transmit operation information indicating an instruction for operation of the database to the master server device, the method comprising:
adding, by the client device, an identifier for identifying the operation information to the operation information;
casing, by one of the server devices, an identifier memory unit to store the identifier of the operation information when changing the database stored in a data storage according to the operation information received from the client device;
causing, by the one of the server devices, a log storage to store a log including the identifier of the operation information when the database according to the operation information is changed;
when the each of the plurality of server devices restarts, restoring, by the one of the server devices, the database stored in the data storage based on the log stored in the log storage, and restoring, by the one of the server devices, a list of the identifier stored in the identifier memory unit based on the identifier included in the log stored in the log storage; and
not changing, by the one of the server devices, the database according to the received operation information in a case where the identifier of the operation information received from the client device is stored in the identifier memory unit.
